(19) United States
(12) Patent Application Publication
(10) Pub. No.: US 2025/0167959 A1
(43) Pub. Date: May 22, 2025

(54) SYSTEM AND METHOD FOR REFERENCE SIGNAL CONFIGURATION, TRANSMISSION AND RECEPTION

(71) Applicant: Huawei Technologies Co., Ltd., Shenzhen (CN)

(72) Inventors: Xiaoyan Bi, Shanghai (CN); Jianglei Ma, Ottawa (CA); Lei Liu, Shanghai (CN)

(21) Appl. No.: 19/028,697

(22) Filed: Jan. 17, 2025

Related U.S. Application Data
(63) Continuation of application No. PCT/CN2022/106242, filed on Jul. 18, 2022.

(51) Int. Cl. H04L 5/00; H04L 25/02

(52) U.S. Cl. CPC H04L 5/0051; H04L 25/0224

(57) ABSTRACT

Embodiments of the application may produce a dramatic reduction in reference signal overhead, enabling channel estimation and acquisition of MIMO with a very large bandwidth in the 10˜13 GHz range and a very ultra large number of antenna ports and a very large number of transmission layers, and exploit channel correlation in time/frequency/spatial domain. Firstly, a new signaling to indicate the topology structure of channel vectors is provided. Secondly, UE behavior is defined in terms of channel estimation and interpolation, based on the indicated topology structure. Thirdly, reference signal patterns are derived, again based on the topology structure.

### CROSS REFERENCE

The application is a continuation of International Application No. PCT/CN2022/106242, filed on Jul. 18, 2022, the disclosure of which is hereby incorporated by reference in its entirety.

### TECHNICAL FIELD

The application relates generally to wireless communication, and more specifically to reference signal configuration, transmission, reception, and to channel estimation and interpolation of received reference signals.

### BACKGROUND

Multiple-input multiple output (MIMO) is a core technology of existing 5G systems, which uses multiple antennas at the transmit end and the receive end to transmit signals and receive signals. The MIMO technology can make full use of space resources and multiplies the channel capacity of the system without increasing spectrum resources or antenna transmit power. Therefore, MIMO still has great potential as one of the core technologies of 6G systems.

A 400 MHz system bandwidth in the 10˜13 GHz range is envisioned as a promising mid-band for wide-area coverage and capacity improvement in 6G systems. In 10˜13 GHz with 400 MHz, it is possible to deploy a ˜1000 transmit/receive (Tx/Rx) antenna array at the base station (BS) side and a ˜30 Tx/Rx antenna array at the user equipment (UE) side, which is far larger than the existing 5G antenna array scale. MIMO will be a key technology for 10˜13 GHz to improve single user-MIMO (SU-MIMO) peak rate with ˜20 layers transmission and network peak throughput with ˜300 layers multiple-user MIMO (MU-MIMO) transmission. How to support such multi-layer SU-MIMO/MU-MIMO transmission is a challenging problem; reference signal (RS) design and channel state information (CSI) acquisition are some of the challenges. The use of ultra-high reference signal overhead and ultra-high algorithm complexity would result in bottlenecks.

Reference signals are used to acquire MIMO channel characteristics at the transmitter side and the effective channel of data transmission at the receiver side. Examples of reference signals include demodulation reference signal (DMRS), sounding reference signal (SRS), and channel state information-reference signal (CSI-RS). The traditional reference signal design and CSI acquisition in Long Term Evolution (LTE) and New Radio (NR) is based on the time/frequency domain channel characteristics (e.g. delay spread, delay, doppler, doppler spread) of a single input single output (SISO) channel. The resources of reference signal are even in the frequency domain and reference signal resource density is limited by the coherence time and coherence bandwidth for the SISO channel. As a SISO channel is invariant within the coherence time and the coherence bandwidth, linear interpolation for the SISO channel is used for channel interpolation.

### SUMMARY

Embodiments of the application may produce a dramatic reduction in reference signal overhead, enabling channel estimation and acquisition of MIMO with a very large bandwidth in the 10˜13 GHz range and a very ultra large number of antenna ports and a very large number of transmission layers, and exploit channel correlation in time/frequency/spatial domain to allow joint channel estimate and interpolation in multiple domains, and enable non-linear channel interpolation algorithms. Key problems of such MIMO applications are solved. Firstly, a new signaling to indicate the topology structure of channel vectors is provided. Secondly, UE behavior is defined in terms of channel estimation and interpolation, based on the indicated topology structure. Thirdly, reference signal resource patterns are derived, again based on the topology structure.

According to one aspect of the present disclosure, there is provided a method comprising: communicating signaling indicating a topology structure of a channel vector and indicating parameters of the topology structure; mapping the topology structure and parameters to a resource pattern of reference signal; and communicating a reference signal on the reference signal resource pattern.

Optionally, the signaling indicating a topology structure indicates a manifold structure.

Optionally, the manifold structure comprises one of: Grassmann, Stiefel, or Riemannian manifold.

Optionally, the parameters of the topology structure comprise one or more of: a chord distance, tangent vector, parallel transport tangent vector, geodesic path, correlation coefficients, Affine Invariant Riemannian Metric, Stein divergence, Jeffrey divergence, Log-Euclidean Metric, projection Frobenius norm, tangent error between two points on the channel manifold.

Optionally, the resource pattern of reference signals has a reference signal resource density that is even or uneven.

Optionally, the signaling indicating a topology structure is port specific or port group specific.

Optionally, communicating the reference signal comprises receiving the reference signal, the method further comprising: performing channel estimation for the reference signal using a method and/or parameters of channel estimation associated with the indicated topology structure and/or the indicated parameters of the topology structure; performing interpolation of channel estimates in reference signal resource locations to obtain channel estimates for non-reference signal resource locations using a method and/or parameters of interpolation associated with the indicated topology structure and/or the indicated parameters of the topology structure.

Optionally, depending on the indicated topology structure and/or the indicated parameters of the topology structure, the method of interpolation associated with the indicated topology structure and/or the indicated parameters of the topology structure is linear or non-linear.

Optionally, the indication of topology structure of the channel vector and parameters of the topology structure are indicated block-wise in time and/or frequency and/or spatial domain.

Optionally, communicating the reference signal comprises receiving the reference signal, the method further comprising: assuming a same topologic structure of intra-block channel vectors; and assuming a different topologic structure of inter-block channel vectors.

Optionally, the method further comprises: for intra-block channel vectors, performing at least one of precoding vector interpolation, reference signal resource placement, channel state information (CSI) compression, channel interpolation, channel estimation based on the same topologic structure and parameters.

Optionally, the reference signal comprises demodulation reference symbols (DMRS).

Optionally, the method as described herein performed by a network device, the method further comprising: determining the topology structure and the parameters of the topology structure; wherein communicating signaling comprises transmitting signaling to an apparatus; wherein communicating the reference signal comprises transmitting the reference signal to the apparatus.

Optionally, the method as described herein performed by an apparatus, wherein communicating signaling comprises receiving signaling from a network device; and communicating the reference signal comprises receiving the reference signal from the network device; the method further comprising: performing channel estimation and interpolation using an algorithm and/or parameters based on the indicated topology structure.

Optionally, the reference signal comprises sounding reference symbols (SRS).

Optionally, the method as described herein performed by a network device, the method further comprises: determining the topology structure and the parameters of the topology structure; wherein communicating signaling comprises transmitting signaling to an apparatus; wherein communicating the reference signal comprises receiving the reference signal from the apparatus.

Optionally, the method as described herein performed by an apparatus, wherein communicating signaling comprises receiving signaling from a network device; and communicating the reference signal comprises transmitting the reference signal to the network device.

Optionally, the reference signal comprises a channel state information reference signal (CSI-RS).

Optionally, the method as described herein performed by a network device, the method further comprises: determining the topology structure and the parameters of the topology structure; wherein communicating signaling comprises transmitting signaling to an apparatus; wherein communicating the reference signal comprises transmitting the reference signal to the apparatus.

Optionally, the method further comprises: receiving feedback comprising compressed channel vectors and constructing channel vectors based on the manifold structure and the feedback.

Optionally, the method as described herein performed by an apparatus, wherein communicating signaling comprises receiving signaling from a network device; and communicating the reference signal comprises receiving the reference signal from the network device.

Optionally, the method of comprises: determining compressed channel vectors based on the received reference signal and transmitting feedback to the network device indicating the compressed channel vectors.

Optionally, the method is performed on a per block basis, where a block is defined in time, frequency or spatial dimensions, wherein a respective topology structure and parameters is associated with each block.

Optionally, the method further comprises: communicating signaling that updates at least one block boundary.

Optionally, the method further comprises: communicating signaling that indicates whether linear or non-linear channel interpolation is to be performed.

Optionally, the mapping the topology structure and parameters to a resource pattern of reference signals is such that: a relatively low reference signal resource density is placed in an area of time/frequency where geometric characteristics change relatively stably, and a relatively high reference signal resource density is placed in an area of time/frequency where geometric characteristics change relatively sharply.

According to another aspect of the present disclosure, there is provided an apparatus comprising: a processor and memory, the apparatus configured to execute the method as described herein.

According to another aspect of the present disclosure, there is provided a network device comprising: a processor and memory, the apparatus configured to execute the method as described herein.

According to another aspect of the present disclosure, there is provided a non-transitory computer readable medium having computer executable instructions stored thereon that when executed by a processor cause execution of the method as described herein

According to one aspect of the present disclosure, there is provided a method comprising: A method comprising: communicating a reference signal on a reference signal resource pattern; wherein the resource pattern of reference signal is derived by or mapped by a topology structure and parameters.

Optionally, wherein the topology structure and parameters are indicated by a signaling from a base station or a network element or a user equipment. The other optional implement can refer to the above statement of an aspect of the present disclosure.

### BRIEF DESCRIPTION OF THE DRAWINGS

Embodiments of the disclosure will now be described with reference to the attached drawings in which:

FIG. 1 is a block diagram of a communication system;

FIG. 2 is a block diagram of a communication system;

FIG. 3 is a block diagram of a communication system showing a basic component structure of an electronic device (ED) and a base station;

FIG. 4 is a block diagram of modules that may be used to implement or perform one or more of the steps of embodiments of the application;

FIG. 5A shows an example of channel topology on a per layer basis for each of six layers;

FIG. 5B shows an example of a channel and data transmission block;

FIG. 6 is a flowchart of a communication method involving DMRS transmission;

FIG. 7 shows an example of DMRS transmission;

FIG. 8 shows example reference signal resource patterns for DMRS transmission;

FIG. 9 is an example of Geodesic based channel vector interpolation;

FIG. 10A is a flowchart of a communication method involving SRS transmission;

FIG. 10B shows an example of SRS transmission;

FIG. 11 is a flowchart of a communication method involving CSI-RS transmission; and

FIG. 12 shows an example of CSI-RS transmission.

### DETAILED DESCRIPTION

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

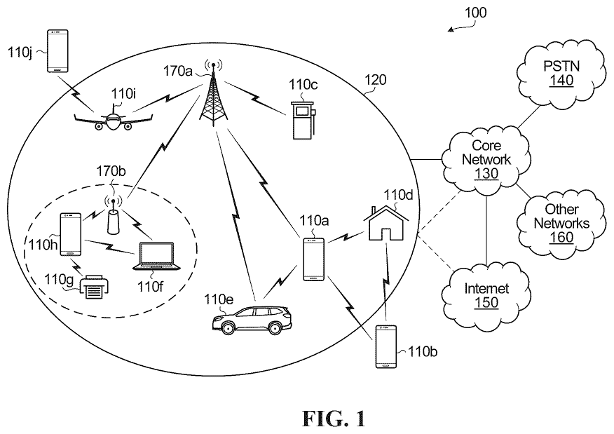

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

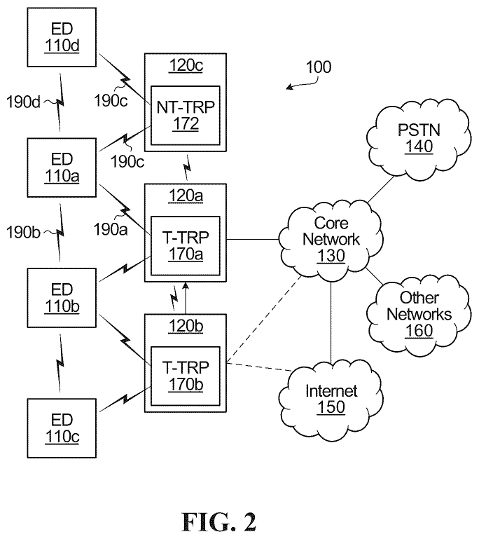

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

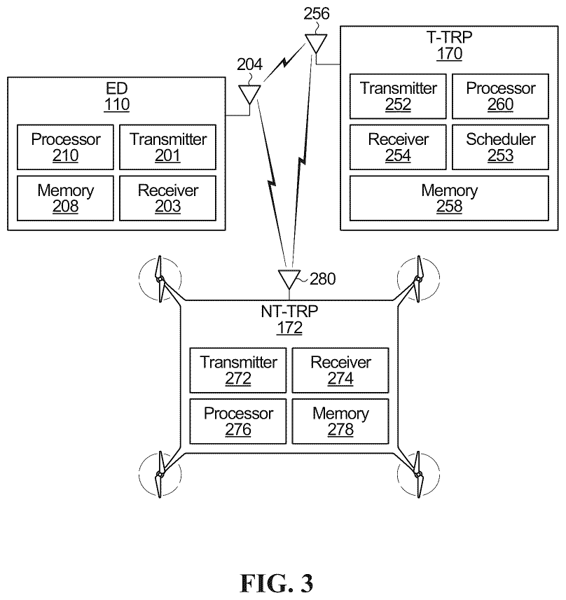

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

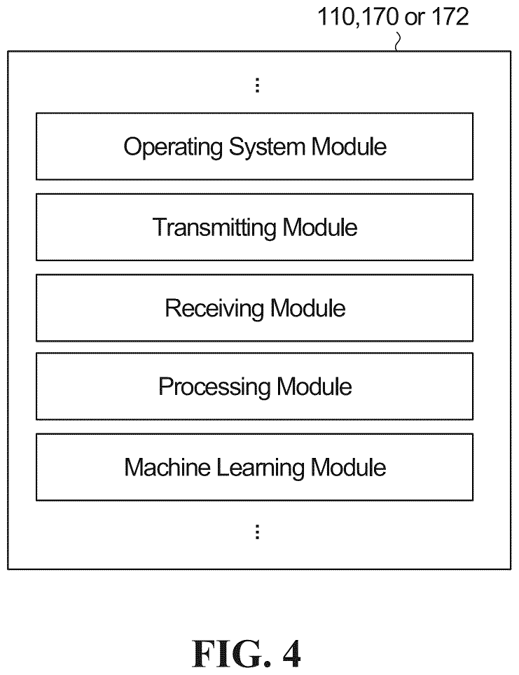

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

As the number of antenna ports and transport layers increases sharply, the number of ports for CSI acquisition increases sharply. Using the NR/LTE traditional reference signal design to acquire CSI causes problems of ultra-high RS overhead and ultra-high algorithm complexity. In NR/LTE traditional mode, resources of reference signal are even in the frequency domain, and the reference signal resource density is limited by the coherence bandwidth. Therefore, resources of reference signal cannot be very sparse. If the reference signal resource density is reduced so as to be greater than the coherent bandwidth to reduce overhead, and channel interpolation is performed based on linear interpolation, the system performance is severely degraded. In addition, a sharp increase in the number of antenna ports requires a large amount of channel estimation processing with high-dimensional matrix calculations, resulting in extremely high calculation complexity.

For SU-MIMO transmission with ˜30 layers and MU-MIMO transmission with ˜300 layers, reference signal design (e.g. DMRS, SRS, CSI-RS) and CSI acquisition are challenging problems. Using the NR/LTE traditional reference signal design method for these contexts will result in ultra-high RS overhead and ultra-high algorithm complexity. Embodiments of the application provide low-overhead reference signal designs and corresponding methods of high-performance channel acquisition for supporting MIMO transmission under ultra-high antenna ports and ultra-high layers.

In accordance with embodiments of the application, the RS design and CSI acquisition problem is solved utilizing channel vector characteristics, enabling linear/non-linear channel interpolation for a MIMO channel. The provided approaches can dramatically reduce reference signal resource overhead in time/frequency and can enable high-performance non-linear channel interpolation for a MIMO channel. At the same time, the provided approaches significantly reduce the calculation complexity through the use of sparse reference signals, requiring a relatively small amount of channel estimation.

Embodiments of the application may produce a dramatic reduction in reference signal resource overhead, enabling channel estimation and acquisition of MIMO with a very large bandwidth in the 10˜13 GHz range and a very ultra large number of antenna ports and a very large number of transmission layers, and exploit channel correlation in time/frequency/spatial domain to allow joint channel estimation and interpolation in multiple domains, and enable non-linear channel interpolation algorithms.

Key problems of such MIMO applications are solved. Firstly, a new signaling to indicate the topology structure of channel vectors is provided. Secondly, UE behavior is defined in terms of channel estimation and interpolation, based on the indicated topology structure. Thirdly, reference signal resource patterns are derived, again based on the topology structure.

To better understand this solution, an example of frequency domain channel topology structure is provided, starting with some definitions. A tensor of the MIMO channel information contains channel information in multiple dimensions such as time domain, frequency domain, space domain. Antenna ports are used to measure space domain resources. Antenna ports are classified into transmit antenna ports and receive antenna ports. An antenna port herein refers to a logical antenna port, and may be the same as or different from a physical antenna port. A time-frequency resource unit, including one or a set of contiguous resource elements (REs), is a minimum unit of the time-frequency domain resource in a block, where an RE is the smallest unit in the physical layer and occupies one OFDM or SC-FDMA symbol in the time domain and one subcarrier in the frequency domain. A time-frequency-space resource unit includes one time-frequency resource unit in the time-frequency domain and one transmit antenna port resource in the space domain. A channel vector refers to channel data (also referred to as channel information) associated with a time-frequency-space resource unit. The channel information may include information such as delay spread, Doppler spread, Doppler frequency shift, average channel gain, average delay, angle of arrival (AoA), zenith angle of arrival (ZoA), zenith angle of departure (ZoD), angle of departure (AOD), spatial correlation (spatial correlation), etc.

A channel matrix refers to channel data associated with a time-frequency resource unit. A channel vector is a row or column of a channel matrix. The dimensions of the channel matrix are the receive antenna port dimension and the transmit antenna port dimension. Assuming that each row of the channel matrix represents one receive antenna port, and each column represents one transmit antenna port, each column of the channel matrix is a channel vector, and the space domain resource of the channel vector refers to the resource on the Nt transmit antenna ports, where Nt denotes the number of transmit antenna ports. When the antenna port is used to transmit a reference signal, the transmit antenna port is referred to an antenna port of reference signal, for example, a DMRS port, an SRS port, a CSI-RS port, etc., and the space domain resource of the channel vector refers to the resource on the antenna ports of reference signal. A tensor of the MIMO channel information can be block-wise in a time-frequency-spatial domain resource. A block comprises channel vectors on a set of contiguous resources in the time domain and the frequency domain and a set of contiguous or non-contiguous resources in the spatial domain. The indication of topology structure for a channel vector can be block-wise in time and/or frequency and/or spatial domain. A detailed definition of a channel and transmission data block is provided below; in some embodiments, the indication of topology structure is for a channel and data transmission block.

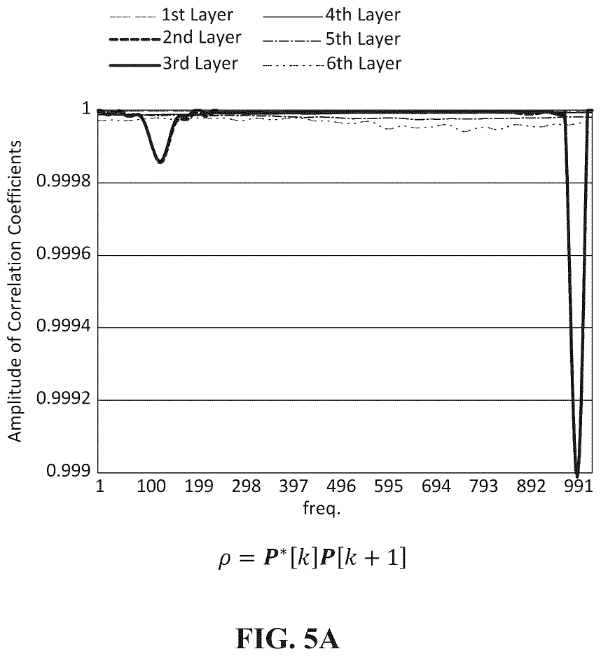

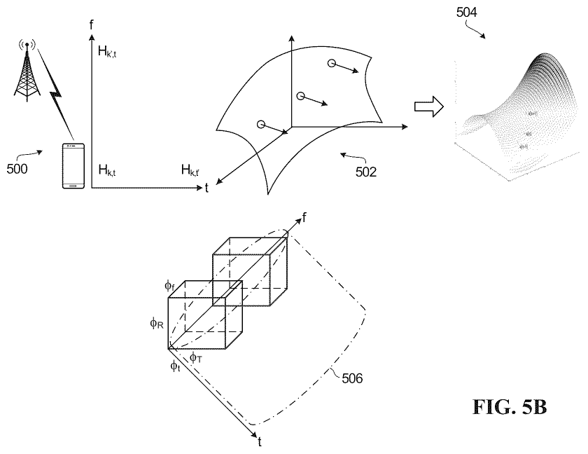

The channel topology structure of the channel vector in the frequency domain may be a measure of correlation between channel vectors on adjacent subcarriers in the frequency domain. In a specific example, channel topology is given by:

$$ρ = P * [ k ] P [ k + 1 ]$$

Where ρ is the correlation between the precoding vector P on for subcarrier k and subcarrier k+1. The precoding implements the mapping of transmission data layers from the layer to the antenna port. There are many manners of obtaining the precoding vector of each MIMO layer. In some specific precoding methods, the precoding vector may represent the channel of the MIMO layer, for example, an SVD-based precoding method. The SVD-based precoding method can divide an entire channel into multiple sub-channels that do not interfere with each other and have different gains, and performing a step per-precoding vector in the method represents performing a step per-sub-channel, used to carry per-MIMO data layer. Thus, the channel topology structure on a per-MIMO layer basis can be represented as the topology structure on a per-precoding vector basis. Based on this method, the topology structure of the precoding vectors in the frequency domain may be obtained, that is, the channel topology structure of the MIMO layers in the frequency domain. An example of channel topology structure on a per-MIMO layer basis for each of six layers is shown in FIG. 5A. It can be seen that the 1^{st}, 4˜6^{th} layers have approximately the same channel topology and the 2^{nd} and 3^{rd} layers have approximately the same channel topology. It is possible to utilize a sparse reference signal resource pattern in combination with information about channel topology at the transmitter and receiver to acquire channel information, thereby reducing reference signal resource overhead.

Signaling is used to indicate a topology structure and parameters of a channel vector, which can be explicitly and/or implicitly used to derive reference signal resource pattern in time and/or frequency and/or code domain, etc. Detailed examples of possible topology structures and parameters are provided below.

When the indication of topology structure is on a per-block basis, the UE can assume channel characteristics of intra-block channel vectors in time and/or frequency and/or space have the same topologic structure and parameters. On the other hand, the UE can assume channel characteristics of channel vectors from different blocks have different topology structures and parameters. In some embodiments, signaling is used to indicate the topology structure of the channel vector in the frequency domain, and the indication information is per antenna port. Channel vectors of one port on all frequency domain resources are assumed to have a same topology structure in one block. It does not appear that there is one topology structure on a portion of contiguous resources of a block and another topology structure on another portion of contiguous resources of a block. Channel vectors of different blocks of one port are assumed to have different frequency domain topologies.

The block-wise topology structure of the channel vector may be predefined or configured by the network or otherwise indicated to a given UE. Based on an indication of channel vector topology structure, a UE can obtain information concerning reference signal resource placement, such as reference signal resource density, location, etc. Based on the channel vector topology structure, a UE may apply a specific algorithm and/or parameters of channel estimation and interpolation, e.g. linear or non-linear channel interpolation, channel interpolation based on topology structure, e.g. Grassmann, Stiefel, Riemannian manifold, etc.

A channel vector is per-port channel data, and in some embodiments, a channel vector can be per-layer channel data. The indication of topology structure could be port-specific or layer-specific. In some embodiments, channel vectors of a group of ports have the same topology structure. The indication of topology structure could be port-group specific or layer group-specific. The indication of topology structure could be UE-specific or cell-specific.

The reference signal may, for example, be SRS, CSI-RS, DMRS for uplink (UL) and/or downlink (DL), or a reference signal for another context such as sidelink. A reference signal resource pattern includes a set of reference signal locations in time/frequency resources. This may involve reference signal density in time/frequency resources; reference signal locations may be evenly or unevenly spaced.

In some embodiments, the topology structure of a channel vector in time and/or frequency and/or spatial domain is a manifold structure. Intra-block channel vectors in time and/or frequency and/or spatial domain could form a smooth manifold; each channel vector is a point of the manifold.

Examples of manifold structures that can be employed include Grassmann manifold structure, Stiefel manifold structure, Riemannian manifold structure. The manifold structure can be described by parameters. The parameters may include at least one of the following metrics: the chord distance, tangent vector, parallel transport tangent vector, geodesic path, correlation coefficients, Affine Invariant Riemannian Metric, Stein divergence, Jeffrey divergence, Log-Euclidean Metric, projection Frobenius norm, tangent error between two points on the channel manifold etc. The above parameters between two points on the manifold can be in spatial/frequency/time domain.

As was the case as described above for block-wise topology structure, the channel characteristics in spatial/frequency/time have the same manifold structure and parameters for a given block. A block manifold structure could be predefined or configured by the network. For example, a gNB may send signaling that indicates a block-wise manifold parameter configuration to UE.

For intra-block channel vectors, the gNB and UE can perform channel vector interpolation, precoding vector interpolation, reference signal resource placement (density/location etc.), CSI compression based on the same manifold structure and parameters. For inter-block channel vectors, the gNB and UE cannot assume the same channel manifold structure and parameters.

The topology characteristics of channel vectors are used as an input to reference signal design instead of the topology characteristics of channel scalars. For example, the geometrical characteristics of a channel manifold can be used as an input to reference signal design. Layer-specific uneven reference signal resource placements can be designed instead of even reference signal resource placements. Reference signal resource placement is no longer limited by coherence time and coherence bandwidth. The resource of reference signal can be placed in a sparse manner, dramatically reducing reference signal resource overhead in time/frequency. Sparse reference signal placement can reduce the times of calculating a large-dimensional matrix as part of the process of obtaining CSI, thereby reducing calculation complexity.

FIG. 5A (500, 502, 504) gives an example to further understand the manifold topology. Generally indicated at 500 are channel matrixes on a set of time-frequency domain resources included in the block. There is a respective N×M MIMO channel matrix Hk,t for each time index t and frequency index k in time-frequency domain. N and M denote receive antenna port number and transmit antenna port number respectively. Each time index t and frequency index k corresponds to a time-frequency resource unit. Assuming that the time-frequency resource unit includes one RE, the time index t and the frequency index k could represent the t^{th} symbol and the k^{th} subcarrier respectively. For each time index t and frequency index k, there are N port (port Index 0˜N−1) channel vectors, respectively corresponding to each column of MIMO channel matrix Hk,t. In a block, some resources are used to transmit reference signals. In 500, reference signals are placed at three resource locations as an example, where the channel matrix is H_{k′,t}, H_{k,t′}, and H_{k,t} respectively.

Generally indicated at 502 is a block channel manifold topology structure formed by channel vectors of channel 500. Channel vectors with different time indexes, different frequency indexes, and different port indexes in a block of channel 500 can form a manifold topology in the time domain and/or frequency and/or spatial domain, and each channel vector is a point on the manifold. The channel vectors on the reference signal resources of channel 500 are three points on the manifold.

Generally indicated at 504 is a mapping of the block manifold structure of 502 to a block reference signal resource pattern. There is a mapping relationship between the manifold structure and the reference signal resource pattern; that is, there is a mapping relationship between the manifold structure and a set of reference signal resource indexes in the time-frequency-space domain resource. The surface in 504 refers to the manifold structure in 502, and the three points on the manifold structure are channel vectors of the three reference signal resources in 500. The coordinates of these three points (for example frequency index k, time index t, port i) in the time-frequency-spatial domain resource coordinate system form the reference signal resource pattern. The coordinate system of 504 refers to the time-frequency-spatial domain resource coordinate system.

Optionally, MIMO channel matrix Hk,t for each time index t and frequency index k could be a dual-polarized channel matrix, a single-polarized channel matrix, a principal subspace matrix of channel, a transmit covariance matrix etc. The transmit covariance matrix can be used to express the MIMO channel matrix according to H_{k,t}=R_{R}^{1/2}H_{idd,k,t}R_{T}^{1/2}, where H_{idd,k,t} denotes an identically distributed channel for each time index t and frequency index k and R_{R},R_{T} denotes receive covariance matrix and transmit covariance matrix of H_{idd,k,t}. The manifold is then mapped to a specific reference signal resource placement indicated generally at 504.

A channel and data transmission block will now be defined. A tensor of the MIMO channel information can be defined block-wise in a time-frequency-spatial domain resource by using a channel and data transmission block. A channel and data transmission block will be described with reference to 506. The channel and data transmission block comprises channel vectors of channels used to carry transmitted data on a set of contiguous resources in time domain and frequency domain and a set of contiguous or non-contiguous resources in spatial domain. The antenna port is a unit of spatial domain resources in the block, where an antenna port refers to a logical transmit antenna port. The channel vectors on spatial domain resources in the block refer to the channel vectors on a group of antenna ports in the block. The time-frequency resource unit and time-frequency-spatial resource unit could be block specific. Channel data associated with a block time-frequency-spatial resource unit is a channel vector.

The channel and the data transmission block may be represented as a four-dimensional tensor, and each element of the tensor is a channel scalar/a channel data and dimensions of the tensor are respectively a time domain dimension, a frequency domain dimension and a transmit antenna port dimension and a receive antenna port dimension.

The channel and the data transmission block may be represented as a four-dimensional tensor. As shown in equation 1 below, the four-dimensional tensor may be represented as a result of performing a modular operation on each dimension of the unit tensor with four coefficient matrices, and the coefficient matrices are respectively a time domain channel coefficient matrix, a frequency domain channel coefficient matrix, a transmit antenna port coefficient matrix and a receive antenna port coefficient matrix. Nᵣ, Nₜ, N_{sc}, N_{symbol} denote the number of receive antenna ports, the number of transmit antenna ports, the number of subcarriers, the number of symbols. H∈ [symbol] ^{N}^{ᵣ}^{×N}^{ₜ}^{×N}^{_{sc}}^{×N}^{_{symbol}} denotes a tensor of channel in a channel and the data transmission block. [symbol] ∈ [symbol] ^{N}^{ᵣ}^{×N}^{ₜ}^{×N}^{_{sc}}^{×N}^{_{symbol}} denotes a unit tensor. xᵢ denotes modular-product operation on the i^{th} dimension of tensor. Φ_{R}, Φ_{T}, Φ_{f}, Φₜ denote a receive antenna port coefficient matrix, a transmit antenna port coefficient matrix, a frequency domain channel coefficient matrix and a time domain channel coefficient matrix respectively. Coefficient matrices may be different due to different channel information, e.g. single-polarized channel, dual-polarized channel, etc. Equations 2-5 below respectively gives a possible expression of the receive antenna port coefficient matrix, a transmit antenna port coefficient matrix, a frequency domain coefficient matrix and a time domain coefficient matrix under a specific channel information. The transmit antenna port coefficient matrix Φ_{T} ∈ [symbol] ^{N}^{ₜ}^{×L} may be a transmit steering vector matrix, which includes transmit steering vectors of L paths. The path refers to the propagation path of wireless signals. For wireless signals, there may be more than one propagation path from a transmit side to a receive side. Therefore, the channel from a transmit side to a receive side may contain multiple paths. L denotes the number of paths of the channel in the block. α_{T}(θᵢ,φᵢ) denotes a transmit steering vector of the i^{th} path, whose elevation angle and azimuth angle are θᵢ and φᵢ, respectively. The receive antenna port coefficient matrix Φ_{R} ∈ [symbol] ^{N}^{ᵣ}^{×L} may be a receive steering vector matrix, which includes receive steering vectors of L paths. α_{R}(θᵢ,φᵢ) denotes receive steering vector of the i^{th} path, whose elevation angle and azimuth angle are θᵢ and φᵢ, respectively. The frequency domain channel coefficient matrix Φ_{f}∈ [symbol] ^{N}^{_{sc}}^{×L} includes frequency domain channel coefficient vectors of L paths. α_{f}(k) denotes channel coefficient vector of k^{th} subcarrier. The time domain channel coefficient matrix Φₜϵ [symbol] ^{N}^{_{symbol}}^{×L} includes time domain channel coefficient vectors of L paths. αₜ(t) denotes channel coefficient vector of t^{th} symbol. l denotes l^{th} path.

The channel and the data transmission block may be represented as a four-dimensional tensor, and each element of the tensor is a channel scalar/a channel data. In the block, the channel scalars on one time-frequency resource unit form a channel matrix. The channel scalars on one transmit antenna port resource form a channel vector, which is a row or a column of the channel matrix. The size of each channel vector may be the number of receive antenna port. A channel vector is composed of Nr channel scalars, a channel vector is a row or a column of the channel matrix. Nr denotes the number of receive antenna port.

$$1. = {\times }_{1} {Φ}_{R} {\times }_{2} {Φ}_{T} {\times }_{3} {Φ}_{f} {\times }_{4} {Φ}_{t}$$

$$2. {Φ}_{R} = [ {α}_{R} ( {θ}_{0} , {φ}_{0} ) , {α}_{R} ( {θ}_{1} , {φ}_{1} ) {α}_{R} ( {θ}_{L} , {φ}_{L} ) ]$$

$$3. {Φ}_{T} = [ {α}_{T} ( {θ}_{0} , {φ}_{0} ) , {α}_{T} ( {θ}_{1} , {φ}_{1} ) {α}_{T} ( {θ}_{L} , {φ}_{L} ) ]$$

$$4. {Φ}_{f} ϵ {ℂ}^{{N}_{sc} \times L} , {Φ}_{f} = [ \begin{matrix}{α}_{f} ( 1 ) \\ ⋯ \\ {α}_{f} ( {N}_{sc} )\end{matrix} ] , {α}_{f} ( k ) = [ 1 , … exp ( j * \frac{2 π ( k - 1 ) l}{{N}_{sc}} ) … exp ( j * \frac{2 π ( k - 1 ) L}{{N}_{sc}} ) ]$$

$$5. {Φ}_{t} ϵ {ℂ}^{{N}_{symbol} \times L} , {Φ}_{t} = [ \begin{matrix}{α}_{t} ( 1 ) \\ ⋯ \\ {α}_{t} ( {N}_{symbol} )\end{matrix} ] , {α}_{t} ( t ) = [ 1 , … exp ( j * \frac{2 π ( t - 1 ) l}{{N}_{symbol}} ) … exp ( j * \frac{2 π ( t - 1 ) L}{{N}_{symbol}} ) ]$$

### DMRS Design and Corresponding Method of Channel Estimation and Interpolation

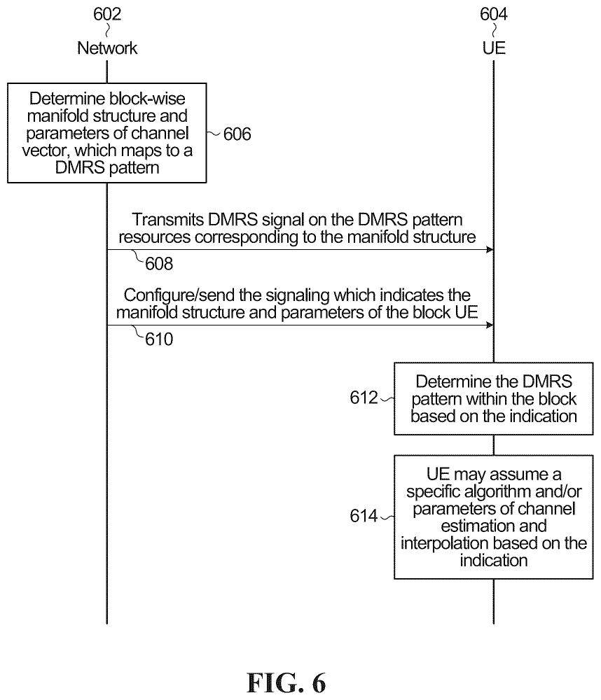

The described approach can be used to design a DMRS resource pattern, and corresponding method of channel estimation and interpolation. A flowchart of a communication method provided by an embodiment of the application is shown in FIG. 6. Shown are steps performed both by the network 602, for example by a gNB, and a UE 604. It should be understood that the flowchart also shows the steps performed by a network, which can be viewed as a method performed by the network, and steps performed by a UE, which can be viewed as a method performed by the UE. In block 606, a gNB determines the block manifold structure and the specific value of parameters of channel vector in time/frequency/spatial domain, which maps to a DMRS resource pattern/resource placement in the time/frequency domain. The block manifold structure is described using the parameters. Different values of the parameter correspond to different manifold structure instances. For ease of understanding, the topology structure may be understood as a function f (e) with a parameter(s) e. In this case, the topology structure indication and the parameter indication respectively represent an indication of a function “f” and an indication of a specific value of the parameter(s).

The manifold structure and parameters of channel vectors may be obtained by a gNB for example using a sensing technology or using an artificial intelligence (AI) model.

Based on the manifold structure, predefine a principal of DMRS resource placement. For each manifold structure, there is a respective principal of DMRS resource placement that is predefined. The DMRS resource placement follows the geometrical characteristics of the channel manifold. For example, based on the geometric characteristics, a relatively low reference signal density is placed in an area of time/frequency where the geometric characteristics change stably, and a relatively high reference signal density is placed in an area of time/frequency where the geometric characteristics change sharply. The geometric characteristics can be described and indicated using one or more of the parameters. Depending on the indication of the manifold structure and the value of parameters, an instance of the manifold structure can be obtained. According to the principle of DMRS resource placement, a manifold structure instance can be mapped to a specific reference signal resource pattern.

The DMRS resource pattern/resource placement includes DMRS density (e.g. even or uneven in frequency and time domain) and DMRS location in the time/frequency domain. In some embodiments, density of DMRS in frequency could be implicitly associated with channel vector flatness and channel quality for a given MIMO layer.

At 608, the gNB transmits a DMRS signal using the DMRS resource pattern corresponding to the manifold structure. As noted previously, according to the manifold structure, the DMRS resource placement/resource pattern of given MIMO layers can be obtained. In a specific example, the gNB transmits DMRS signals of given layers on the DMRS resource elements (REs) of the given layers.

In 610, the gNB configures/sends the signaling which indicates the manifold structure and parameters of the block to a UE. The gNB may send the signaling to the UE by using higher layer signaling or physical layer signaling. For example, the higher layer signaling may include radio resource control (radio resource control, RRC) signaling, Media Access Control (Media Access Control, MAC) signaling, or other higher layer signaling. The physical layer signaling may include downlink control information (downlink control information, DCI) signaling, other physical layer signaling, or the like.

The indication of manifold structure can be UE-specific or cell-specific. The indication of the parameters of the manifold can be layer-specific or layer-group specific for a given UE.

In some embodiments, multiple manifold structures and parameters are configured by the gNB or predefined, and then the gNB indicates a manifold structure and parameters as among the configured options by using higher layer signaling. For example, semi-persistent RRC signaling may be employed, in which case the indication of channel manifold may be adjusted semi-persistently; in this case, the indication is not adjusted in real time. As such this approach is applicable to a scenario in which channel characteristics change relatively slowly. This embodiment has lower signaling overheads.

In some embodiments, multiple manifold structures and parameters are configured by the gNB or predefined, and then the gNB indicates a manifold structure and parameters as among the configured options by using dynamic DCI signaling. In this manner, the indication of channel manifold may be adjusted closer to real-time, dynamically, and flexibly; better communication performance can be obtained with this approach in a scenario in which channel characteristics change rapidly.

In block 612, the UE determines the DMRS resource pattern within the block based on the indication of manifold structure and parameters. Based on the indication of manifold structure and the predefined principal of DMRS resource placement, the UE can derive the DMRS resource pattern/resource placement of given layers in time/frequency domain within a block.

In block 614, the UE applies a specific algorithm and/or parameters of channel estimation and interpolation based on the indication of manifold structure and parameters. Within a block, the UE performs channel vector estimation of given layers based on the DMRS REs. Within a block, the UE assumes the precoding matrix in time/frequency domain transmitted by gNB follow the same manifold structure and parameters, so that the UE can perform non-linear/linear channel vector interpolation based on the same manifold structure. When obtaining the channel state information from the DMRS, the UE performs channel interpolation in time domain and frequency domain according to an indication of the channel topology. A prerequisite for accurate interpolation is that manifold topology structures and parameters of the precoding matrix and the channel matrix are the same.

Within a block, the UE assumes the precoding matrix and effective channel matrix on all REs within a block follow the same manifold structure and parameters, and performs MIMO equalization based on the interpolated channel vector. During data transmission, the UE performs MIMO equalization based on channel vectors estimated and interpolated based on the channel topology structure in the previous paragraph. A prerequisite for accurate MIMO equalization is that manifold topology structures and parameters of the effective channel matrix and the channel matrix are the same.

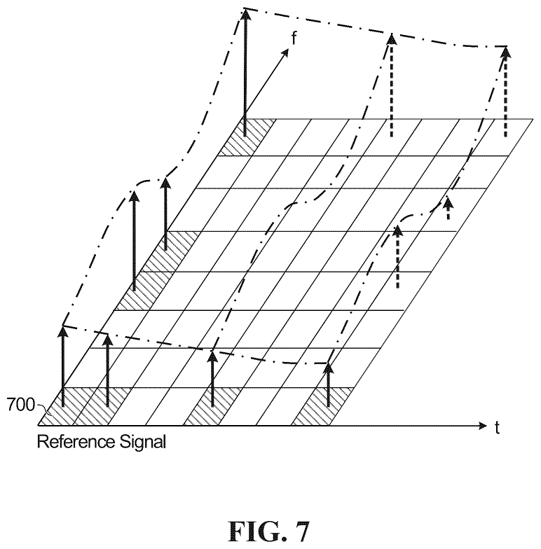

FIG. 7 shows an example of DMRS transmission. Time is on the horizontal axis (symbol duration) and frequency (e.g. OFDM sub-carrier) is on the vertical axis. The shaded resource elements 700 form a resource pattern assigned for DMRS transmission. The resource pattern is obtained based on the signaled manifold structure and parameters that are signaled per block, where a block is 8 symbol durations by 8 OFDM subcarriers in this example. In FIG. 7, the surface outlined by the dashed line refers to the channel manifold structure. The arrows represent mapping relationships between channel vector per RE and points on the manifold; the solid arrows represent DMRS channel vectors, and the dashed arrows represent PDSCH data vectors. This example shows the resource positions of only one DMRS port.

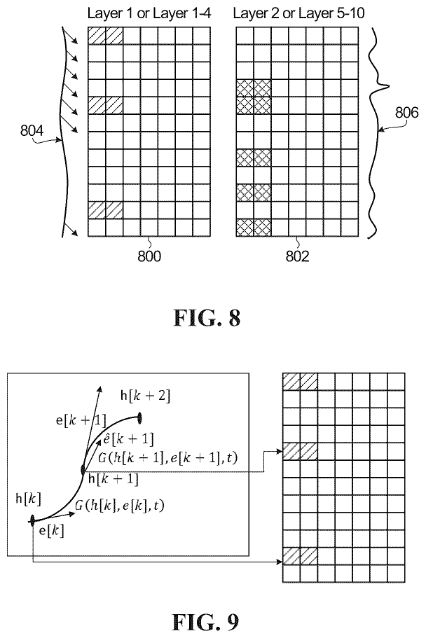

FIG. 8 shows another example reference signal resource pattern, including a first resource pattern generally indicated at 800 for layer 1 (of two layers) or layer 1˜4 (of 10 layers), and a second resource pattern generally indicated at 802 for layer 2 (of two layers) or layers 5˜10 (of 10 layers). It can be seen the reference signal resource patterns are layer specific in this example. In the example, two curves 804,806 respectively represent channel topology structures in frequency domain of layer 1 (of two layers) or layer 1˜4 (of 10 layers) and layer 2 (of two layers) or layers 5˜10 (of 10 layers), and two reference signal resource patterns are obtained by mapping according to the topology structures of the two.

### SRS Design and Corresponding Method of Channel Estimation and Interpolation

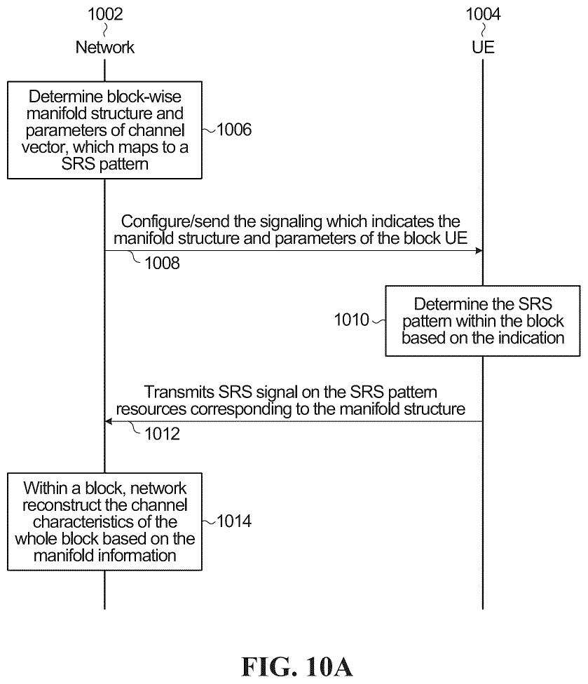

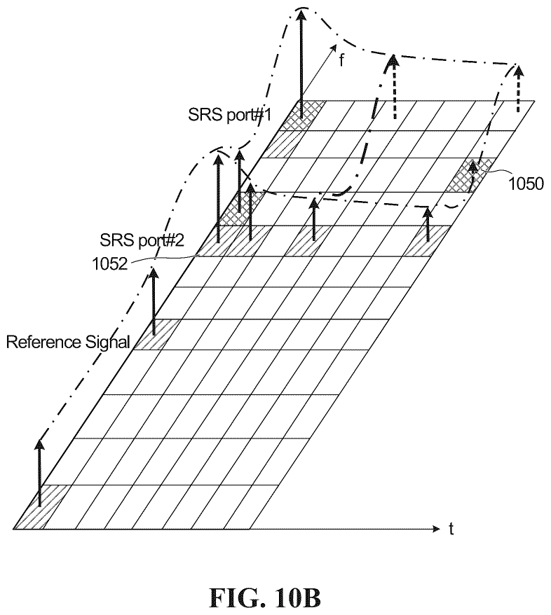

The described approach can be used to design an SRS reference signal resource pattern, and corresponding method of channel estimation and interpolation. A flowchart of a communication method provided by an embodiment of the application is shown in FIG. 10A. Shown are steps performed both by the network 1002, for example by a gNB, and a UE 1004. It should be understood that such flowchart also shows the steps performed by a network, which can be viewed as a method performed by the network, and steps performed by a UE, which can be viewed as a method performed by the UE. The SRS design and channel estimation and interpolation problem is solved by utilizing manifold structure of a MIMO channel vector, enabling linear/non-linear channel interpolation for the MIMO channel vector.

In block 1006, a gNB determines a block-wise manifold structure and parameters of a channel vector in Time/Frequency/Spatial domain, which map to an SRS resource pattern in Time/Frequency domain.

Based on the manifold structure, predefine a principal of SRS resource placement. For each manifold structure, there is a respective principal of SRS resource placement that is predefined. The SRS resource placement follows the geometrical characteristics (e.g. manifold parameters) of the channel manifold. For one SRS port, a relatively low reference signal resource density is placed in an area of Time/Frequency where the geometric characteristics change stably, and a relatively high reference signal resource density is placed in an area of Time/Frequency where the geometric characteristics change sharply. Different SRS ports may have different manifold parameter values and different reference signal resource densities within the block. For example, for two SRS ports with different topologies, at a few physical resource blocks (PRB)/subcarrier/subbands of a block, the UE may send two SRS ports, and at the other PRBs/subcarriers/subbands of a block, UE may send partial port SRS, e.g. only Port #1 SRS is transmitted. In another example, at one or more symbol/TTI/slots of a block, the UE may send two SRS ports, and at the other symbol/TTI/slots of a block, the UE sends partial port SRS, e.g. only Port #1 SRS is transmitted.

At 1008, the gNB configures/sends the signaling which indicates the manifold structure and parameters of the block to the UE. The indication of manifold structure can be UE-specific or cell-specific. The indication of the parameters of the manifold structure can be layer-specific or layer-group specific for a given UE. In block 1010, the UE determines the SRS resource pattern within the block based on the indication. At 1012, the UE transmits an SRS signal on the SRS resource pattern resources corresponding to the manifold structure. Within a block, UE transmits the same port based on the same RF chain/precoding (if needed) and the same power control parameters.

In block 1014, within a block, the network may reconstruct the channel characteristics of the whole block based on the manifold information. This involves, for example, the network performing channel estimation on the reference signal resources. Within a block, the network may reconstruct the channel characteristics of the whole block based on the manifold information by a specific algorithm and/or parameters of channel interpolation (non-linear or linear) based on the indication of manifold structure and parameters. The precoding matrix can be obtained by using the interpolated channels based on the manifold structure.

The existing NR SRS resource pattern supports a maximum of 4 ports per UE, where patterns/densities of all ports are the same and are evenly placed in frequency domain with high reference signal density (Comb 4/Comb2). In this embodiment, the reference signal resource placement follows the geometric characteristics of the channel manifold. Thus, this embodiment supports port-specific reference signal resource pattern and reference signal resource density. For example, some ports with stable channel changes are configured with sparser reference signals, and some ports with fast channel changes are configured with denser reference signals. Compared with the same reference signal resource density for all ports, this embodiment may greatly reduce reference signal resource overheads when maintaining the same channel estimation performance. Lower reference signal density (such as Comb 48) in frequency domain may be configured for some ports. In addition, this embodiment supports an uneven reference signal design. For example, a denser reference signal is configured in some areas where a channel changes quickly in time/frequency/space domain, and a sparser reference signal is configured in some areas where a channel changes slowly in time/frequency/space domain, which may greatly reduce reference signal resource overheads when maintaining the same channel estimation performance compared with even reference signal resource placement. Compared with NR, the reference signal design scheme in this embodiment supports more users or more ports for channel estimation. Based on the channel manifold structure, non-linear channel interpolation can be designed and used to construct the whole channels of all REs in a block. The channel interpolation method makes use of the geometrical characteristics of channel vectors to perform non-linear higher-performance channel interpolation.

FIG. 10B shows an example of SRS transmission. Time is on the horizontal axis (symbol duration) and frequency (e.g. OFDM sub-carrier) is on the vertical axis. The shaded resource elements 1050,1052 form a resource pattern assigned for SRS transmission for SRS port #1 and SRS port #2 respectively.

### CSI-RS Design and Corresponding Method of Channel Estimation and Interpolation

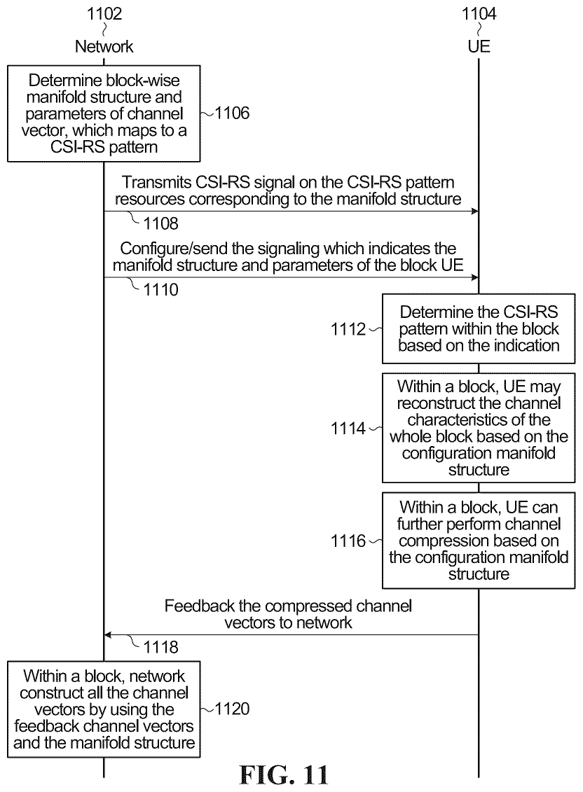

The described approach can be used to design an CSI-RS reference signal resource pattern, and corresponding method of channel estimation and interpolation. A flowchart of a communication method provided by an embodiment of the application is shown in FIG. 11. Shown are steps performed both by the network 1102, for example by a gNB, and a UE 1104. It should be understood that such flowchart also shows the steps performed by a network, which can be viewed as a method performed by the network, and steps performed by a UE, which can be viewed as a method performed by the UE. The CSI-RS design and channel estimation and interpolation problem is solved by utilizing manifold structure of a MIMO channel vector, enabling linear/non-linear channel interpolation for the MIMO channel vector.

In block 1106, the network determines a block-wise manifold structure and parameters of a channel vector, which maps to a CSI-RS pattern.

Based on the manifold structure, predefine a principal of CSI-RS resource placement. For each manifold structure, there is a respective principal of CSI-RS resource placement that is predefined. The reference signal resource placement follows the geometrical characteristics (e.g. manifold parameters) of the channel manifold. For one SRS port, a relatively low reference signal resource density is placed in an area of Time/Frequency where the geometric characteristics change stably, and a relatively high reference signal resource density is placed in an area of Time/Frequency where the geometric characteristics change sharply. Different CSI-RS ports may have different manifold parameter values and different reference signal resource densities within the block. For example, for two CSI-RS ports with different topologies, at a few of PRB/subcarrier/subbands, the network may send two CSI-RS ports, and at the other PRBs/subcarriers/subbands of a block, the network may only send a partial CSI-RS port, e.g. only Port #1 SRS is transmitted. In another example, at a few of symbol/TTI/slots of a block, the UE send two CSI-RS ports, and at the other symbol/TTI/slots of a block, the UE only sends a partial CSI-RS port, e.g. only Port #1 SRS is transmitted.

At 1108, the network transmits a CSI-RS signal on the CSI-RS resource pattern resources corresponding to the manifold structure. At 1110, the network configures/sends the signaling which indicates the manifold structure and parameters of the block to UE. The indication of manifold structure a can be UE-specific or cell-specific. The indication of the parameters of manifold can be layer-specific or layer-group specific for a given UE. At block 1112, the UE determines the CSI-RS resource pattern within the block based on the indication.

At block 1114, within a block, the UE may reconstruct the channel characteristics of the whole block based on the configured manifold information. The UE performs channel estimation on the reference signal resources. Within a block, the UE may reconstruct the channel characteristics of the whole block based on the manifold information by a specific algorithm and/or parameters of channel interpolation (none-linear or linear) based on the indication of manifold structure and parameters.

At block 1116, within a block, the UE can further perform channel compression based on the configured manifold structure and feedback the compressed channel vectors to the network at 1118.

At block 1120, within a block, the network constructs all channel vectors by using the feedback channel vectors and the manifold structure. Network may reconstruct the channel characteristics of the whole block based on the manifold information by a specific algorithm and/or parameters of channel interpolation (none-linear or linear) based on the indication of manifold structure and parameters.

The existing NR CSI-RS resource pattern supports a maximum of 32 ports, where patterns/densities of all ports are the same and are evenly placed in frequency domain. In this embodiment, a low-resource-overhead CSI-RS resource pattern that supports thousands of CSI-RS ports and sparser the frequency density can be employed. The reference signal resource placement follows the geometrical characteristics of channel manifold. Each port may have layer-specific even or non-even CSI-RS pattern/density. The reference signal of this embodiment can be sparser and can dramatically reduce reference signal resource overhead in time/frequency compared to a reference signal that satisfies coherence time and bandwidth constraints.

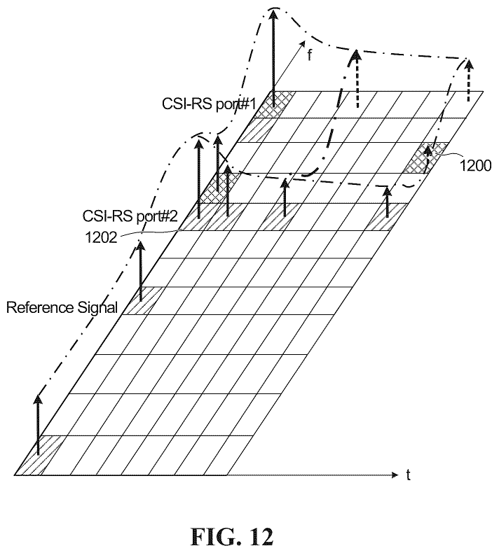

An example of a block with two CSI-RS ports configured with sparse reference signal resource patterns is shown in FIG. 12. The reference signal resource pattern for CSI-RS port #1 is indicated at 1200 (first hatching) and the reference signal resource pattern for CSI-RS port #2 is indicated at 1202 (second hatching).

Based on the channel manifold structure, non-linear channel interpolation can be designed and used to construct the whole channels of all REs in a block, which has higher construction precision than that of even interpolation.

### Method of Non-Linear Channel Interpolation of Channel Vectors for a Grassmann Manifold Topology Structure

Another embodiment provides a method of non-linear channel interpolation of channel vectors for Grassmann manifold topology structure. N-dimensional Unit MIMO channel vectors on all subcarriers can form a Grassmann manifold [symbol] _{N,1}, which is a set of subspaces spanned by the N-dimensional Unit MIMO channel vector. The channel manifold structure is described by a geodesic.

h[k], k=1, 2, . . . , m, are the channel vector estimated on reference signal resources, which may be not evenly located in time/frequency domain, where, m is the total number of reference signal resources in time/frequency domain and [symbol] , k=1, 2, . . . , m are the channel vectors with unit norm estimated on reference signal resources.

$$= \frac{h [ k ]}{‖ h [ k ] ‖}$$

The channel vectors on the radio resource without reference signal can be interpolated based on a geodesic. Unit Channel vectors on two adjacent reference signal resources are [symbol] and h [symbol] and unit channel vectors on non-reference signal resources may be obtained by interpolation using the following formula. Assuming that the number of resources to be interpolated is s, [symbol] = [symbol] , [symbol] = [symbol] , and the unit channel vectors obtained by interpolation is [symbol] , 1≤i≥s. The corresponding channel vectors obtained by interpolation is hᵢₙ[i]=A[i]* [symbol] , where A[i] is the norm of channel vector.

$$= G ( , e [ i ] , ρ [ i ] ) = ρ [ i ] ( + \vec{e} [ i ] tan ( {‖ e [ i ] ‖}_{2} ) )$$

$$where ,$$

$$=$$

$$= G ( , e [ s + 1 ] , ρ [ s + 1 ] ) = ρ [ s + 1 ] ( + \vec{e} [ s + 1 ] tan ( {‖ e [ s + 1 ] ‖}_{2} ) ) =$$

ρ[s+1] and e[s+1] and A[s+1] can be calculated by the following equations:

$$ρ [ s + 1 ] = *$$

$${‖ e [ s + 1 ] ‖}_{2} = {tan}^{- 1} ( \frac{\sqrt{1 - {\vert ρ [ s + 1 ] \vert}^{2}}}{ρ [ s + 1 ]} )$$

$$\vec{e} [ s + 1 ] = \frac{\frac{ρ [ s + 1 ]}{} -}{\frac{\sqrt{1 - {\vert ρ [ s + 1 ] \vert}^{2}}}{\vert ρ [ s + 1 ] \vert}}$$

$$e [ s + 1 ] = {‖ e [ s + 1 ] ‖}_{2} * \vec{e} [ s + 1 ]$$

$$A [ s + 1 ] = ‖ h [ k + 1 ] ‖$$

In the above, ρ[i] is the correlation coefficients of channel vectors of [symbol] and [symbol] . e[i] is the tangent vector of channel vectors of [symbol] and [symbol] , whose norm is ∥e[i]∥₂, whose unit tangent vector is

$$\vec{e} [ i ] = \frac{e [ i ]}{{‖ e [ i ] ‖}_{2}} .$$

A[i] is the norm of channel vector [symbol] .

UE may implicitly derive ρ[i] and e[i] and A[i] using the relationship between ρ[i] and ρ[s+1], and e[i] and e[s+1] and A[s+1].

ρ[i] and e[i] and A[i] could be both explicitly configured or dynamically indicated by gNB. Or one of ρ[i] and e[i] and A[i] could be configured by gNB, and the other two could be implicitly derived by UE. Or two of ρ[i] and e[i] and A[i] could be configured by gNB, and the other one could be implicitly derived by UE.

ρ[i] and e[i] and A[i] could be obtained by training at gNB or UE side, respectively by using sensing assisted channel structure training/acquisition or AI assisted channel structure training/acquisition.

In some embodiments, signaling is used to indicate linear or non-linear channel interpolation. Linear and non-linear channel interpolation configuration may be based on UE capability.

This embodiment provides a new non-linear channel interpolation of channel vectors for Grassmann manifold topology structure. The channel manifold structure is described by a geodesic. This embodiment provides a new geodesic based interpolation function applicable for complex channel vectors. Compared with linear interpolation of channel scalar, this approach has higher performance.

In some embodiments, Geodesic based channel vector interpolation is employed. An example is shown in FIG. 9. This interpolation method makes use of the geometrical characteristics of channel vectors to perform non-linear higher-performance channel interpolation. FIG. 9 shows another example of a reference signal resource pattern. The shaded resource elements are the reference signal resources of one DMRS port, which occupies 6 REs on two symbols. The other resource elements in the first two columns in the Figure are resources of the to-be-interpolated channel. The curve in the left square represents the manifold structure of the channel vector in the frequency domain. h[k],h[k+1],h[k+2] are the channel vectors estimated on reference signal resources, which corresponds to three points on the manifold structure. e[k],e[k+1] are tangent vectors of the first and second points. G(h[k],e[k],t) and G(h[k+1],e[k+1],t) are the geodesic line from the first point to the second point and the geodesic line from the second point to the third point, respectively. t is a parameter of geodesic line. ê[k+1] is a parallel tangent vector of the second point.

The existing NR DMRS resource pattern supports a maximum of 12 DMRS ports, where patterns/densities of all ports are the same and are evenly placed in frequency domain. In this embodiment, a low-resource-overhead DMRS resource pattern that supports hundreds of DMRS ports can be designed. The reference signal resource placement follows the geometrical characteristics of a channel manifold. Each port may have layer-specific even/non-even DMRS pattern/density. The reference signal resource placement of this embodiment is sparser and can dramatically reduce reference signal resource overhead in time/frequency.

### Block Boundary Updating

In some embodiments, the definition of the block boundaries is updated from time to time. In some embodiments, signaling is used to indicate or feedback updated boundary information of a block.

When a channel feature (for example, paths) of a UE in a block changes and is no longer the same as a previous channel topology, boundary information of the block in time/frequency domain can be updated. This allows block definitions to be maintained in manner that are suitable to changing channel conditions.

The block boundary in frequency and time domain could be updated by gNB or UE, which can obtain channel statistical information assisted by sensing.

In one example, the gNB transmits signaling to the UE, which is used to indicate an update to block boundary information in frequency and time domain. Based on sensing assisted information, gNB can detect or predict a block boundary in frequency and time domain and based on that the gNB can trigger transmission of an indication to update the block boundary.

In another example, the UE sends a signaling to a gNB, which is used to indicate/request an update of a block boundary. Based on sensing information at UE side or channel measurement on the configured RS transmitted by gNB, the UE can detect the channel characteristics/manifold variation in frequency and time domain. A principle or metric threshold of channel manifold may be pre-defined. Once the channel manifold variation meets the predefined threshold, UE can trigger a feedback to update the boundary of block.

In this embodiment, boundary information of a block can be dynamically updated according to a change of channel characteristics or channel topologies, thus the topology structure of a block can be dynamically changed, thereby further improving system performance.

Numerous modifications and variations of the present disclosure are possible in light of the above teachings. It is therefore to be understood that within the scope of the appended claims, the disclosure may be practiced otherwise than as specifically described herein.

For example, while the embodiments have been described in the context to communication between a base station and a terminal, the same approach can be applied communication between terminals, or to satellite communications and the like. The provided methods may be applied to a communications system such as satellite communications, and includes a satellite base station and a terminal type network element, and is also applicable to intersatellite communications. Other example application contexts include communication between a base station and a base station, the Internet of Vehicles, the Internet of Things, the industrial Internet, and the like.

The provided methods are also applicable to wireless projection. Typical application scenarios include wireless projection, VR games, and data encoding and decoding in mobile apps.

The provided methods are applicable to both homogeneous network and heterogeneous network scenarios, and there is no limitation on transmission points, which may be multi-point coordinated transmission between macro base stations and macro base stations, between micro base stations and micro base stations, and between macro base stations and micro base stations. This feature applies to both LTE FDD and LTE TDD systems. The embodiments are not only applicable to a low frequency scenario (sub 6G), but also applicable to a high frequency scenario (above 6G), terahertz, optical communication, and the like.

The embodiments may be applicable to a 5G communications system, a 6G communications system, a future evolved communications system, another communications system, or the like.

1. A method comprising:
communicating signaling indicating a topology structure of a channel vector and indicating parameters of the topology structure;
mapping the topology structure and the parameters to a reference signal resource pattern; and
communicating a reference signal on the reference signal resource pattern.

2. The method of claim 1, wherein the signaling indicates a manifold structure.

3. The method of claim 2, wherein the manifold structure comprises one of: a Grassmann manifold, a Stiefel manifold, or a Riemannian manifold.

4. The method of claim 2, wherein the parameters of the topology structure comprise one or more of:
a chord distance, a tangent vector, a parallel transport tangent vector, a geodesic path, a correlation coefficients, an Affine Invariant Riemannian Metric, a Stein divergence, a Jeffrey divergence, a Log-Euclidean Metric, a projection Frobenius norm, or a tangent error between two points on a channel manifold.

5. The method of claim 1, wherein the reference signal resource pattern has a reference signal resource density that is even or uneven.

6. The method of claim 1, wherein the signaling is port specific or port group specific.

7. The method of claim 1, wherein the communicating the reference signal comprises receiving the reference signal, the method further comprising:
performing channel estimation for the reference signal using at least one of a channel estimation method or channel estimation parameters associated with at least one of the topology structure or the parameters of the topology structure; and
performing interpolation of channel estimates in reference signal resource locations to obtain channel estimates for non-reference signal resource locations using at least one of an interpolation method or interpolation parameters associated with at least one of the topology structure or the parameters of the topology structure.

8. The method of claim 7, wherein depending on at least one of the topology structure or the indicated parameters of the topology structure, the interpolation method associated with the at least one of the topology structure or the parameters of the topology structure is linear or non-linear.

9. The method of claim 1, wherein the topology structure of the channel vector and the parameters of the topology structure are indicated block-wise in at least one of the time domain, the frequency domain, or the spatial domain.

10. The method of claim 9, wherein the communicating the reference signal comprises receiving the reference signal, the method further comprising:
assuming a same topologic structure of intra-block channel vectors; and
assuming a different topologic structure of inter-block channel vectors.

11. The method of claim 10, further comprising:
for the intra-block channel vectors, performing at least one of precoding vector interpolation, reference signal resource placement, channel state information (CSI) compression, channel interpolation, or channel estimation based on the same topologic structure and parameters of the same topologic structure.

12. The method of claim 1, wherein the reference signal comprises demodulation reference symbols (DMRSs).

13. The method of claim 12, wherein the method is performed by a network device, the method further comprising:
determining the topology structure and the parameters of the topology structure,
wherein the communicating the signaling comprises transmitting the signaling to an apparatus, and
wherein the communicating the reference signal comprises transmitting the reference signal to the apparatus.

14. The method of claim 12, wherein the method is performed by an apparatus, wherein:
the communicating the signaling comprises receiving the signaling from a network device, and
the communicating the reference signal comprises receiving the reference signal from the network device,
the method further comprising:
performing channel estimation and interpolation using at least one of an algorithm or parameters based on the topology structure.

15. A method comprising:
communicating a reference signal on a reference signal resource pattern, wherein the reference signal resource pattern is derived by or mapped by a topology structure and parameters of the topology structure, and
wherein the topology structure and the parameters are indicated by signaling from a base station or a network element or a user equipment.

16. An apparatus comprising:
one or more processors, when executing program instructions stored in the apparatus, cause the apparatus to perform operations including:
communicating signaling indicating a topology structure of a channel vector and indicating parameters of the topology structure;
mapping the topology structure and the parameters to a reference signal resource pattern; and
communicating a reference signal on the reference signal resource pattern.

17. The apparatus of claim 16, wherein the signaling indicates a manifold structure.

18. The apparatus of claim 16, wherein the communicating the reference signal comprises receiving the reference signal, and the operations further comprise:
performing channel estimation for the reference signal using at least one of a channel estimation method or channel estimation parameters associated with at least one of the topology structure or the parameters of the topology structure; and
performing interpolation of channel estimates in reference signal resource locations to obtain channel estimates for non-reference signal resource locations using at least one of an interpolation method or interpolation parameters associated with at least one of the topology structure or the parameters of the topology structure.

19. The apparatus of claim 16, wherein the topology structure of the channel vector and the parameters of the topology structure are indicated block-wise in at least one of the time domain, the frequency domain, or the spatial domain.

20. An apparatus comprising:
one or more processors, when executing program instructions stored in the apparatus, cause the apparatus to perform operations including:
communicating a reference signal on a reference signal resource pattern, wherein the reference signal resource pattern is derived by or mapped by a topology structure and parameters of the topology structure, and
wherein the topology structure and the parameters are indicated by signaling from a base station or a network element or a user equipment.
